(19) United States
(12) Patent Application Publication
(10) Pub. No.: US 2007/0099699 A1
(43) Pub. Date: May 3, 2007

(54) Novel enhanced image entertainment and laser engraving site and method of engraving an image

(76) Inventor: Anatoly Plotkin, Studio City, CA (US)

Correspondence Address: GREENBERG TRAURIG LLP, 2450 COLORADO AVENUE, SUITE 400E, SANTA MONICA, CA, 90404, US

(21) Appl. No.: 11/262,199

(22) Filed: Oct. 28, 2005

(51) Int. Cl. A63F 9/24; B23K 26/00

(52) U.S. Cl. 463/30; 219/121.68

(57) ABSTRACT

Disclosed is an image entertainment site that inputs an image and engraves the image with a laser engraver. A live display of the user's image being engraved is displayed to the user. It may also be displayed to passers-by. The image entertainment site may also include a game allowing for a user to compete for a chance to win an engraving at a reduce price. Also disclosed is the method of using an image entertainment site. A user tenders payment. Thereafter an image is inputted and engraved by a laser engraver.

### BACKGROUND

Visitors to malls, amusement parks, and other places of recreation often memorialize their visits with photographs. To do so, visitors must generally bring their own photography equipment. These days, however, many places of amusement now offer photography sites allowing visitors to memorialize their visits without the need to bring their own photography equipment.

Many of these photography sites are of limited entertainment value. Visitors spend a short time posing for a camera and receive only a collection of small photographs. Within the art, great potential for more entertaining sites exist. Information relevant to attempts to address these problems may be found in U.S. Pat. Nos. 4,677,460; 5,343,386; 5,500,700; 5,539,453; 5,623,581; 5,897,220; 5,913,019; 6,021,417; 6,141,482; 6,231,196; 6,317,560; 6,523,034; 6,718,123; and Publication Nos. US 2004/0186792; US 2005/0075153; and US 2005/0171906.

However, each one of these references suffer from one or more of the following disadvantages: their utility is limited to photographic processes, their overall entertainment value is limited, they do not provide a form of entertainment to passers-by or other observers, or they do not perform laser engraving. Thus, these various limitations make the present disclosure more desirable than the cited references and are demonstrative of satisfaction of a longstanding need in the art addressed and overcome according to the teachings of the present disclosure.

### SUMMARY

The present disclosure is directed to an image entertainment site, among other things. The site comprises an apparatus for inputting images. The images are then laser engraved onto a material suitable for being engraved with a laser engraver. A computer controls the laser engraving process. A user may watch the engraving process on a display. The users operate the site after depositing a sum of money. At least one input member allows users to select from various options, including optionally a game of chance or skill. The user may opt not to tender additional payment and forfeit the opportunity to engrave an image.

Briefly stated, disclosed is an image entertainment site that inputs an image and engraves the image with a laser engraver. The site displays a live display of the user's image being engraved to the user. The live image may also be displayed to passers-by. The image entertainment site optionally includes a game allowing for a user to compete for a chance to win an engraving. Likewise disclosed is the method of using an image entertainment site. A user tenders payment. Thereafter an image is inputted and engraved by a laser engraver.

As previously indicated, the present disclosure in an embodiment contemplates a built-in game. If the user achieves a specific outcome of the game, an engraving is made. If the specific outcome does not occur and the user initially paid a partial payment that allowed the user to input an image and play the game, then the user may tender an additional payment to bring the total payment at least equal to the full price and have the inputted image engraved, subject to local regulations and law. If the user tendered the full price for an engraving, the inputted image is engraved regardless of the outcome of the game; the occurrence of the specific outcome, however, entitles the user to a second engraving of the image.

The present disclosure analyzes the images inputted and can remove background elements. In an embodiment, the laser engraver engraves only the foreground images rather than using substitute background images. A computer algorithm is utilized by the computer to digitally remove the background elements by converting the first image, which is inputted from a input device, to a second image without background elements.

Many materials are suitable for laser engraving. The present disclosure is well-suited to engraving the materials of wood, plastic, acrylic, glass, coated materials, ceramics, cloth, leather, marble, matte board, paper, mylar, pressboard, metal, rubber, wood veneer, fiberglass, and other laser engraveable materials known in the art.

The present disclosure optionally includes a second display. The second display shows a live image of the laser engraving process to passers-by and other observers. It is positioned where passers-by and other observers may view the live image of the laser engraving process. Alternatively, the second display can display advertising materials.

A method for making a laser engraving is also disclosed. The image entertainment site accepts a payment from a user. Thereafter, a first image is inputted. The first image may be converted into a second image, which may be devoid of background elements, as described above. In an embodiment, a user can select a specific region of the image to laser engrave with at least one input member prior to having the image laser engraved. After payment and input of the image, the user may optionally play a game for a chance to win an engraving. As known to those skilled in the art, related combinations of the above features are expressly contemplated and within the scope of this case.

According to a feature of the present disclosure a novel enhanced image entertainment site is taught comprising, in combination, a device for inputting an image, a device for collecting payment, a laser engraver, a computer, a first display, and at least one input member, wherein at least one input member is used to interact with the image entertainment site, and wherein the site displays a live representation of a laser engraving process on at least the first display, which is located in a first viewing position, whereby a user of the image entertainment site may observe the live representation of the laser engraving process.

Also taught according to a feature of the present disclosure is a novel enhanced image entertainment site comprising, in combination, a device for inputting an image, a device for collecting payment, a laser engraver, a computer, a first display, a game, and at least one input member, wherein at least one input member is used to interact with the image entertainment site, and wherein if a specific outcome of the game occurs, then an engraving is made.

Another feature of the present disclosure provides for a novel enhanced method of engraving an image that comprises the steps of, in combination, accepting a first payment, inputting a first image with an input device, engraving an image with a laser engraver, and displaying a live image of the engraving process on at least the first display, wherein the first image comprises background and foreground elements.

An additional feature taught by the present disclosure is a novel enhanced method of engraving an image that comprises the steps of, in combination, accepting a first or second payment, inputting a first image with an input device, and presenting a game for the user to play; wherein the first image comprises background and foreground elements; wherein the outcome determinative event of the game is based on at least one selection chosen from the group consisting of skill and chance; wherein if a specific outcome of the game occurs, then an engraving is made.

### DRAWINGS

The above-mentioned features and objects of the present disclosure will become more apparent with reference to the following description taken in conjunction with the accompanying drawings wherein like reference numerals denote like elements and in which:

FIG. 1 is a block diagram of an embodiment of the present disclosure showing an interrelationship between elements;

FIG. 2 is a sectional view of an embodiment of the present disclosure, illustrated schematically;

FIG. 3 is a flow chart demonstrating an embodiment of a process of inputting an image and engraving it; and

FIG. 4 is a flow chart of an embodiment of the process a user of the present disclosure may undertake to obtain an engraving.

### DETAILED DESCRIPTION

The present disclosure teaches a novel enhanced image entertainment and laser engraving site and method of engraving an image. Briefly, the present disclosure is a novel combination of elements comprised of an image input device, a computer that processes the inputted image, and a laser engraver for engraving images. Users tender a payment to operate the present disclosure and may use related options.

One configuration of the present disclosure displays a live image of the laser engraver engraving a material suitable for engraving on at least one display. Such live images, according to an example of the present disclosure, may be displayed to a user on a first display and to passers-by and other observers on at least one additional display.

In addition to these embodiments, the present disclosure optionally includes a built-in game. Users may play the game in an attempt to win a laser engraving. According to another embodiment, a user tenders a reduced payment to input an image and play the game. After inputting the image, the user plays the game. Upon reaching a specific game outcome, the user receives an engraving. However, if the specific game outcome does not occur, then the user may tender an additional payment in order to obtain a laser engraved image. The user may opt not to tender additional payment, but in that event, the user forfeits the opportunity to engrave an image. If the user initially tendered the full price and the specific game outcome occurs, the user wins a second engraving.

Also taught in the present disclosure is a method for using an image entertainment site to make a laser engraving. According to a method of the instant teachings, a user tenders a payment. Then a first image is inputted, which is subsequently engraved with a laser engraver.

Once inputted, first image may be converted into a form suitable for laser engraving. A contemplated method for the converting of an image into a form suitable for engraving allows a user to remove the background elements from the image. Thus, only the foreground elements get engraved according to this method. In an alternative embodiment, the user selects the portions of the image to laser engrave, or uses related processes and choices to create a user-defined image.

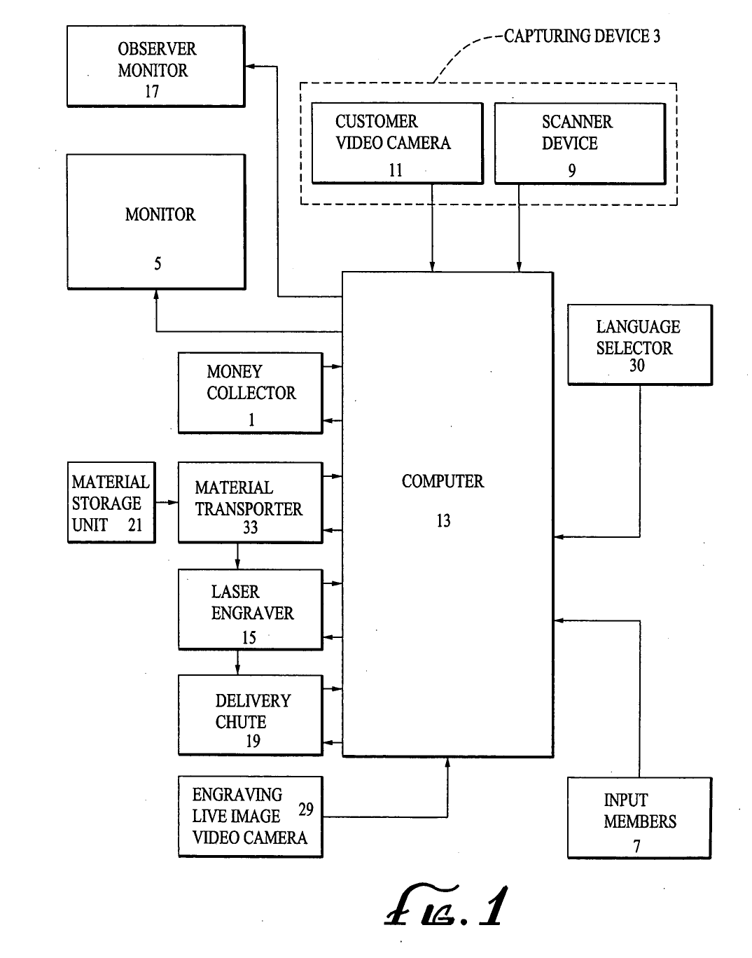

FIG. 1 represents a block diagram of one embodiment of the present disclosure. According to an embodiment, users operate the machine after tendering a specific payment. Money collector 1 accepts payment. An example of a suitable money collector 1 is a combination of one or more paper money collectors, coin collectors, token collectors, credit card chargers, or other collectors known in the art.

Referring still to FIG. 1 and an embodiment of the present disclosure, after money collector 1 accepts the payment and completes a verification that the user tendered a payment at least equal to a specific amount of money necessary to activate the machine, electricity is supplied to one or more peripheral devices, which may conserve power by remaining in a reduced power configuration while the present disclosure is unused by a user. Such devices, as shown in FIG. 1, can include a combination of input device 3, user monitor 5, laser engraver 15, observer monitor 17, engraver video camera 29, and other devices requiring electricity, as would be known to those skilled in the art.

The user may select from one or more languages in which to interact with the image entertainment site as shown in an embodiment in FIG. 1 having language selector 30. Language selector 30 allows the user to choose to interact with the image entertainment site in a plurality of languages. The languages are preloaded into the image entertainment site's computer. The language may be toggled by actuating language selector 30 at any time during the use of the site. Language selector 30 may be any number of switching devices as known by one skilled in the art.

According to FIG. 1 and an embodiment of the present disclosure, input device 3 is used to input first image 23. One embodiment of input device 3 is comprised of a camera or video camera 11 that captures and inputs an image of the user as first image 23. The user may use at least one input member 7 to control camera or video camera 11 and select the subject matter of the captured image. Another embodiment allows the user to digitally alter first image 23 with at least one input member 7. Those skilled in the art understand that conventional video technology can be interchanged with the listed cameras and video machines discussed. Other image-capturing technology, either presently known or developed in the future, can be easily used as well as input device 3.

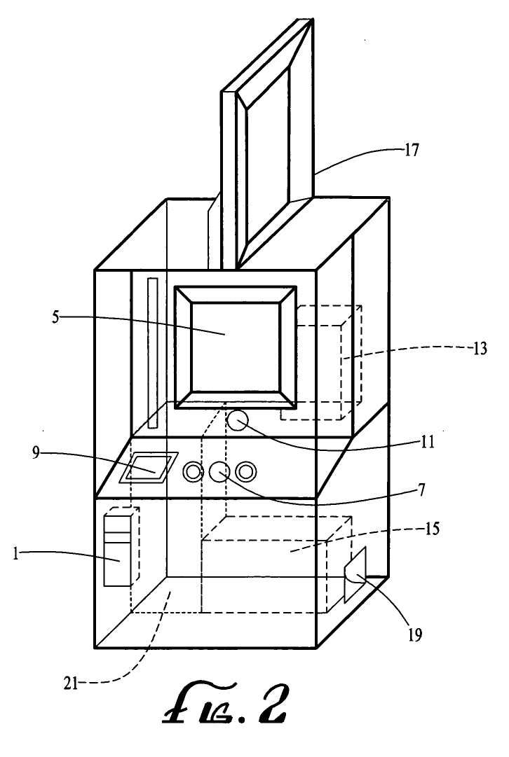

Referring now to FIG. 2, along with FIG. 1, those skilled in the art will understand that according to another embodiment, input device 3 is scanning device 9. The user supplies a scannable image. A user may bring in photos, drawings, and other media suitable for scanning and use scanning device 9 to capture and input the media as first image 23.

Embodiments of the present disclosure allow input device 3 to employ a number of user-selectable options including a countdown device, the ability to freeze and unfreeze live images from camera or video camera 11, and the capture and input of a plurality of first images 23 via user camera or video camera 11 or scanning device 9. These embodiments are not mutually exclusive, but may be included as features in combination with other embodiments of the present disclosure.

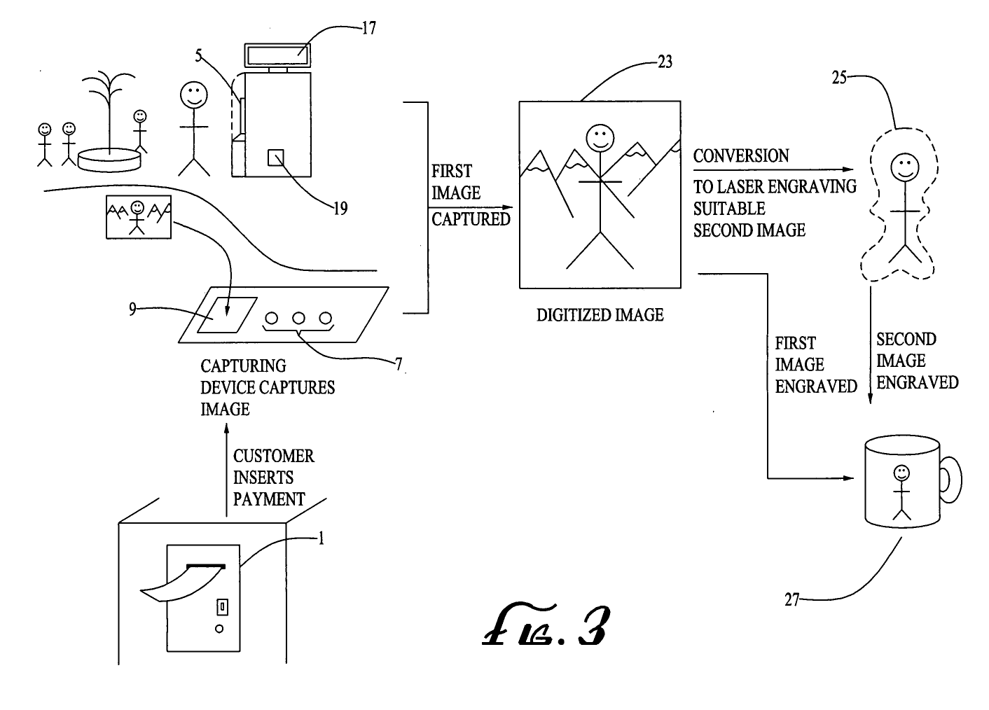

In an embodiment using camera or video camera 11 or scanning device 9 as input device 3, a countdown device displays the time interval before activation of input device 3 and capture of first image 23. In an embodiment, the user may activate the input process depicted in FIG. 3. Before input device 3 captures first image 23, the countdown device displays the number of seconds the user must wait before input device 3 captures first image 23. First display 5 displays first image 23 to the user. The user may then optionally accept first image 23 and proceed with the laser engraving process or reject first image 23 and start the capturing process again.

Input device 3 may also input a plurality of first images 23 in another variation of an embodiment of the input process as depicted in FIG. 3. First display 5 then displays all first images 23. The user selects one or more of the plurality of first images 23 to send to laser engraver 15 for engraving. If user sends multiple first images 23 to laser engraver 15 for engraving, user must tender additional payment.

The user manifests choices for options presented by the present disclosure through the use of at least one input member 7. In an embodiment, first display 5 displays options to the user. Using at least one input member 7, the user makes selections that tailor the experience of the present disclosure. Moreover, in an embodiment, the user actuates at least one input member 7 to play a game. Input member 7 can be at least one button, one or more keyboards or keypads, one or more joysticks, one or more touch screens, one or more touch pads, one or more voice controls, one or more computer mice, or other input devices known in the art or a combination thereof to allow users to interact with the device. Other input members that may be utilized are likewise contemplated and within the scope of this disclosure.

Referring to FIG. 3, a computer algorithm is used to convert first image 23 into second image 25. In an embodiment, use of the computer algorithm may remove, but not replace, background elements from first image 23. The computer algorithm used to convert first image 23 to second image 25 can be implemented in various ways as known in the art. 35 As an alternative embodiment also reflected in FIG. 3, input device 3 inputs first image 23 in a form suitable for laser engraving. Thus, no conversion process is necessary in this embodiment. The form in which first image 23 or second image 25 is stored is commonly known in the art.

Laser engraver 15 engraves first image 23 or second image 25 onto an engraveable material suitable for laser engraving 25. Engraveable material 27 may be, but is not limited to, any of the following materials: wood, plastic, acrylic, glass, coated materials, ceramics, cloth, leather, marble, matte board, paper, mylar, pressboard, metal, rubber, wood veneer, fiberglass, and other laser engraveable materials known in the art. The parameters that laser engraver 15 uses for each specific engraveable material 27 are either known in the art or may be discovered without undue experimentation.

Referring back to the embodiment reflected in FIG. 1, engraveable material 27 is stored in material storage unit 21. Prior to engraveable material 27 being engraved by laser engraver 15, material transporter 33 removes one or more specimens of engraveable material 27 from material storage unit 21 and inserts them into laser engraver 15 in a configuration in which laser engraver 15 may successfully engrave engraveable material 27. Computer 13 controls material transporter 33 in a manner known in the art. After laser engraver 15 engraves first image 23 or second image 25 onto engraveable material 27, the engraved engraveable material 27 is delivered to the user via delivery chute 19.

Referring still to the embodiment shown in FIG. 1, one or more live images of the laser engraving process are displayed on first display 5. Engraving video camera 29 transmits one or more video images of the engraving process to at least one display, including first display 5 via computer 13.

According to the teachings of a similar embodiment, the same live images of the engraving process are viewable on observer monitor 17. Observer monitor 17 is positioned in a location where passers-by or other observers may observe the laser engraving process. Observer monitor 17 may also be used for advertising purposes.

In an embodiment, the user, by making a full or reduced first payment, may also play a game in an attempt to win a laser engraving. If the user tendered full payment, then user competes for a second engraving. If the user tendered a partial payment then the user attempts to win a first engraving. Upon the occurrence of a specific outcome of the game, such as a certain minimum score or random event, the process of making an engraving as described previously occurs. If the user tendered the full amount, then a second engraving is made.

In the event the specific outcome does not occur, the user may tender additional payment, via money collector 1, in order to receive a laser engraving if a reduced first payment was initially tendered. In an embodiment, an additional payment tendered renders the total payment, defined as the reduced first payment plus the additional payment, greater than or equal to the cost to make an engraving by tendering the full amount initially. In the event the specific outcome does not occur and the full payment was made initially, the process of making an engraving as previously described occurs. The present disclosure contemplates both games of skill, such as pinball, and games of chance, such as a video slot machine.

An embodiment of the game is stored and executed on computer 13 connected to first display 5. Once started, the user interacts with the game with at least one input member 7 connected to computer 13.

The present disclosure may further comprise an audio device allowing the user to hear sounds associated with the game. When the game ends and the specific outcome occurs, first display 5 shows a message informing the user of the winning outcome, which may be accompanied by a plurality of audio outputs that may be chosen, linked, or stored as conventionally known. Audio features may optionally be associated with the other elements and processes of the present disclosure.

An embodiment of the present disclosure allows the user to input a personalized message with at least one input member 7. The personalized message becomes a part of second image 25 as part of a conversion process of converting first image 23 to second image 25. In this way, the present disclosure allows the user to make personalized greeting cards, comprised of at least one engraveable material 27 and other items suitable for displaying words, logos, trade symbols, or trademarks in combination with the image engraved.

In a similar embodiment frames can also be appended. The frames can be user-selected, random, or default borders appended to second image 25 in the conversion process as described previously. Thus, the present disclosure allows a user to make greeting cards with frames. Similarly, other engraveable materials 27 may have a frame engraved with first image 23 or second image 25 as discussed above.

Another contemplated embodiment allows the user to put their own engraveable material 27 into the laser engraver 15 to be engraved. The user inserts engraveable material 27 into laser engraver 15. Laser engraver 15 senses the boundaries of the engraveable material, ensuring that first image 23 or second image 25 is correctly engraved on engraveable material 27 by laser engraver 15, as known to those skilled in the art.

For example, laser engraver 15 may have a secondary laser. The secondary laser emits a beam of light across an engraving chamber where engraveable material 27 is positioned. Light sensors on the opposite side of the chamber detect the presence or absence of light from the secondary laser. Each sensor not detecting the presence of light from the secondary laser indicates where engraveable material 27 is present. Thereafter, the user may further restrict the area that may be engraved within the boundaries sensed by the secondary laser by using a computer program that displays the boundaries of engraveable material 27 sensed by the secondary laser. User selects the restricted engraving area displayed on user monitor 5 using at least one input member 7.

If, in an embodiment, the user wishes to order additional engravings, then the user may tender a specific additional payment and receive additional engravings. Alternately, another embodiment allows the user to order additional engravings from a remote location. According to the teachings of this embodiment, users receive a code corresponding to first image 23 or second image 25. The image entertainment site uploads first image 23 or second image 25 via, for example, an internet protocol for later retrieval. If ordered, the additional laser engravings produced off site are shipped to or picked up by the user.

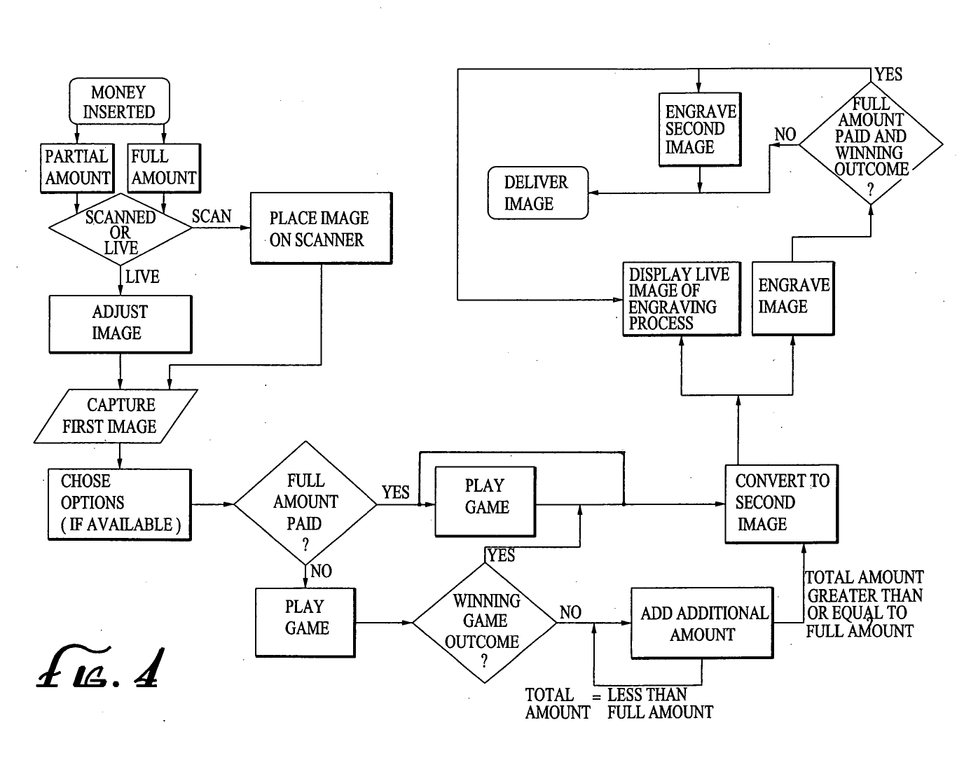

FIG. 2 further demonstrates an embodiment of the present invention as executed by the method of FIG. 4. The user tenders payment to money collector 1. The user tenders a full payment or a partial payment. User selects the form of the input device 3 as either camera or video camera 11 or scanning device 9. Variations using other imaging technology are likewise contemplated. After inputting an image, the user may play a game to win an engraving.

Referring still to the method shown by the embodiment of FIG. 4, if the user selects the input device 3 to be camera or video camera 11, user monitor 5 displays a live or preview image. Using at least one input member 7, user may adjust the position of camera or video camera 11 to adjust the subject matter displayed in the live image or preview image on first display 5. Once the user is satisfied with camera or video camera 11 placement, the first display 5 displays a countdown in seconds until user camera or video camera 11 captures first image 23. The present disclosure expressly contemplates display of a live or preview image with other input devices 3 as well.

If input device 3 is scanning device 9, user places a tangible medium containing the image on scanning device 9. Scanning device 9 captures first image 23. In an embodiment, user can also bring a computer storage device with images created elsewhere to be saved by computer 13 as first image 23. Such an image may be contained on CD, DVD, flash media, floppy disk, or other computer storage media known in the art or later developed.

In an embodiment, user may then use at least one input member 7 to select an engraveable material 27 to be engraved. User may also choose, using at least one input member 7, to insert personalized messages or frames, crop portions of first image 23, or perform other manipulations of digital images commonly known in the art and available in commercial image editing software, such as Adobe Photoshop. Digital modifications are appended to first image 23 as part of the conversion process to second image 25. Laser engraver 15 then engraves second image 25 in the engraving process. The user may also select other options, in an embodiment, such as the material to be engraved or the addition of a logo. In an embodiment, the user has the ability to specify background elements in first image 23 that the user wishes to remove in the conversion process to form second image 25.

In an embodiment, prior to laser engraving engraveable material 27 by laser engraver 15, the image to be engraved is converted to a form suitable for engraving, as known in the art, such as gray scale. An arbitrary number of gray scale values may be chosen, where each value is represented by a different gray scale darkness level. Laser engraver 15 may represent the various gray scale values, for example, by varying the density of shading marks used to represent each gray scale value. It is to be understood by one in the art that conversion to gray scale is but one method of converting an inputted image into an image suitable for engraving. Other methods commonly known in the art are also expressly contemplated.

Referring still to the embodiment of FIG. 4, once the user completes selection of options, then first image 23 is converted to second image 25 by the use of a computer algorithm. During the conversion process, the computer algorithm is used to remove background features and append any selected options such as personalized messages, frames, logos, or other selected options to be engraved with modified first image 23. Computer algorithm may also be used to convert first image 23 into second image 25 by changing it into gray scale.

According still to an embodiment of FIG. 4, the user has the option to play a game for a chance to win an engraving. If a specific outcome of the game occurs, for example, a score greater than 20,000 points or three cherries, then the user is notified that he or she has won a free engraving or a similar winning indication. If the specific outcome does not occur and the user tendered only a partial payment amount, then the user may tender additional payment. The additional payment brings the value of the total payment tendered greater than or equal to an initial full payment for an engraving. First image 23 can be converted to second image 25 in the image conversion step at any point after first image 23 has been input. Because partial payment is consideration to have an image inputted and play a game, the user may later choose not to tender additional payment, but in that event the user forfeits the opportunity to engrave an image. If the specific outcome does not occur and the user paid the full amount, the inputted image is still engraved; if the specific outcome occurred and the user paid the full amount, a second engraving of an image is made.

Referring still to the embodiment of FIG. 4, once first image 23 is converted to second image 25, the engraving process commences. At a point after the user's selection of engraveable material 27, material transporter 33 moves selected engraveable material 27 from material storage unit 21 to laser engraver 15. Computer 13 activates laser engraver 15 after engraveable material 27 is placed in laser engraver 15 as previously described. Laser engraver 15 then engraves first image 23 or second image 25 onto engraveable material 27. Engraveable material 27 is delivered to the user via delivery chute 19. Engraver video camera 29 transmits a live image of the engraving process to first display 5 and to observer display 17. Variations on this theme are also included within the scope of the present invention.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A novel enhanced image entertainment site comprising, in combination:
(a) a device for inputting an image;
(b) a device for collecting payment;
(c) a laser engraver;
(d) a computer;
(e) a first display; and
(f) at least one input member, wherein at least one input member is used to interact with the image entertainment site; and
wherein the site displays a live representation of a laser engraving process on at least the first display, which is located in a first viewing position, whereby a user of the image entertainment site may observe the live representation of the laser engraving process.

2. The image entertainment site of claim 1, wherein the device for inputting an image is at least one apparatus selected from a group of input devices including: a scanning device, a camera, a video camera, a computer storage device, and combinations of these apparatus.

3. The image entertainment site of claim 1 further comprising a game;
wherein if a specific outcome of the game occurs, then an engraving is made.

4. The image entertainment site of claim 1 further comprising a second display;
wherein the second display is located in a second viewing position where observers not operating the image entertainment site may observe the live representation of the laser engraving process simultaneous with the display of the process on the first display.

5. The image entertainment site of claim 1 further comprising a digital background remover;
wherein the digital background remover is capable of removing at least one background element of the image and the digital background remover is driven by a computer algorithm.

6. The image entertainment site of claim 1 further comprising an engraveable material on which an engraving process occurs;
wherein the engraveable material is at least one substrate chosen from a group consisting of: wood, plastic, acrylic, glass, coated materials, ceramics, cloth, leather, marble, matte board, paper, mylar, pressboard, metal, rubber, wood veneer, fiberglass, and combinations of the substrate materials.

7. The image entertainment site of claim 1 further comprising a language selector.

8. A novel enhanced image entertainment site comprising, in combination:
(a) a device for inputting an image;
(b) a device for collecting payment;
(c) a laser engraver;
(d) computer;
(e) a first display;
(f) a game;
(g) at least one input member, wherein at least one input member is used to interact with the image entertainment site;
wherein if a specific outcome of the game occurs, then an engraving is made.

9. The image entertainment site of claim 8, wherein the device for inputting an image is at least one apparatus selected from a group of inputting devises including: a scanning device, a camera, a video camera, a computer storage device, and combinations of these apparatus.

10. The image entertainment site of claim 8, wherein a live representation of the laser engraving process is displayed on at least the first display, which is located in a first viewing position, whereby a user of the image entertainment site may observe the live representation of the laser engraving process.

11. The image entertainment site of claim 8 further comprising a second display;
wherein the second display is located in a second viewing position where observers not operating the image entertainment site may observe the live representation of the laser engraving process simultaneous to the display of the process on the first display.

12. The image entertainment site of claim 8 further comprising a digital background remover;
wherein the digital background remover is capable of removing at least one background element of the image and the digital background remover is driven by a computer algorithm.

13. The image entertainment site of claim 8 further comprising an engraveable material on which an engraving process occurs;
wherein the engraveable material is chosen from at least one substrate from a group consisting of: wood, plastic, acrylic, glass, coated materials, ceramics, cloth, leather, marble, matte board, paper, mylar, pressboard, metal, rubber, wood veneer, fiberglass, and combinations of the substrate materials.

14. The image entertainment site of claim 8 further comprising a language selector.

15. A novel enhanced method of engraving an image that comprises the steps of, in combination:
(a) accepting a first payment;
(b) inputting a first image with an input device;
(c) engraving an image with a laser engraver; and
(d) displaying a live image of the engraving process on at least the first display:
wherein the first image comprises background and foreground elements.

16. The method of claim 15 further comprising the step of converting the first image into a second image;
wherein the image engraved is the second image.

17. The method of claim 16 wherein the conversion step comprises at least one of the following steps consisting of a group of:
(a) removing at least one background element;
(b) appending at least one text element; and
(c) appending at least one graphical element.

18. The method of claim 15 further comprising the additional steps of:
(a) displaying the first image on a first display; and
(b) allowing a user to use at least one input member to select a region of the first image to be engraved.

19. The method of claim 15 further comprising the additional steps of:
(a) inputting at least one additional first image with the input device; and
(b) allowing a user to use at least one input member to select at least one first image to be engraved.

20. The method of claim 19 further comprising the step of allowing the user to use at least one input member to choose a region within the selected first image for engraving.

21. The method of claim 15 further comprising the step of allowing a user to play a game;
wherein an outcome determinative event of the game is based on at least one selection chosen from a group consisting of skill and chance;
wherein if a specific outcome of the game occurs, then an engraving is made.

22. The method of claim 16 wherein the conversion step further comprises the steps of:
(a) converting the first image into a second image comprised of gray scale values; and
(b) engraving the second image by representing gray scale values by at least one of:
varying the density of shading marks for each gray scale value; and
varying the depth that the engraver engraves each gray scale value into an engraveable material.

23. The method of claim 15 comprising the additional step of allowing a user to select one of a plurality of languages in which the user interacts with an image entertainment site.

24. A novel enhanced method of engraving an image that comprises the steps of, in combination:
(a) accepting a payment;
(b) inputting a first image with an input device;
(c) presenting a game for a user to play;
wherein the first image comprises background and foreground elements;
wherein an outcome determinative event of the game is based on at least one selection chosen from a group consisting of skill and chance;
wherein if a specific outcome of the game occurs, then an engraving is made.

25. The method of claim 24 further comprising the step of converting the first image into a second image;
wherein the image engraved is the second image.

26. The method of claim 25, wherein the conversion step comprises at least one of the following steps consisting of a group of:
(a) removing at least one background element;
(b) appending at least one text element; and
(c) appending at least one graphical element.

27. The method of claim 24 further comprising the additional steps of:
(a) displaying the first image on a first display; and
(b) allowing the user to use at least one input member to select a region of the first image to be engraved.

28. The method of claim 24 further comprising the additional steps of:
(a) inputting at least one additional first image with the input device; and
(b) allowing the user to use at least one input member to select at least one first image to be engraved.

29. The method of claim 28 further comprising the step of allowing the user to use at least one input member to choose a region within the selected first image for engraving.

30. The method of claim 25 wherein the conversion step comprises the steps of:
(a) converting the first image into a second image comprised of gray scale values; and
(b) engraving the second image by representing gray scale values by at least one of:
varying the density if shading marks for each gray scale value; and
varying the depth that the engraver engraves each gray scale value into an engraveable material.

31. The method of claim 24 comprising the additional step of allowing a user to select one of a plurality of languages in which the user interacts with an image entertainment site.
